(19) United States
(12) Patent Application Publication
(10) Pub. No.: US 2014/0164924 A1
(43) Pub. Date: Jun. 12, 2014

(54) Self Service Portal and Methods for Using Same

(71) Applicant: Senzari, Inc., Miami, FL (US)

(72) Inventors: Demian M. Bellumio, Miami, FL (US); Sue Sealock, Miami Beach, FL (US)

(73) Assignee: Senzari, Inc., Miami, FL (US)

(21) Appl. No.: 14/091,913

(22) Filed: Nov. 27, 2013

Related U.S. Application Data
(60) Provisional application No. 61/732,183, filed on Nov. 30, 2012.
(60) Provisional application No. 61/732,123, filed on Nov. 30, 2012.

(51) Int. Cl. G06F 3/0484

(52) U.S. Cl. CPC G06F 3/0484
USPC 715/716

(57) ABSTRACT

Embodiments of the present disclosure automatically generate customized media player code segments for integration with the websites of an online provider of goods and services to stream various forms of non-downloadable media (such as audio and video) to visitors of the provider's website. Embodiments of the present disclosure further allow online providers to obtain information relating to usage and performance of the media player.

### CROSS-REFERENCE TO RELATED APPLICATIONS

This application claims priority to U.S. Provisional Patent Application Ser. No. 61/732,183, filed Nov. 30, 2012 entitled “SELF SERVICE PORTAL AND METHODS FOR USING SAME” and to U.S. Provisional Patent Application Ser. No. 61/732,123, filed Nov. 30, 2012 and entitled “SYSTEMS AND METHODS FOR PROVIDING A VIRTUAL DEVICE FOR CONTROLLING STREAMING OF MUSIC,” and to the disclosures of which are hereby incorporated herein by reference.

### TECHNICAL FIELD

Embodiments of the present disclosure relate to a self service portal and method for using same. More particularly, embodiments of the present disclosure provide a customized streaming media player to provide content to visitors of an online provider's website.

### BACKGROUND

The internet has advanced so that it is commonplace for users to navigate the websites of online providers of goods and services for purchase of such goods and services. Many such online providers wish to provide streaming media (such as background music) for the enjoyment of visitors navigating the online provider's website. Among other things, the streaming of music can make navigating the provider's website more enjoyable and/or less stressful as compared to doing this when there is no music/background music.

Many online providers may also wish to provide musical options to the visitors of their websites so that the visitors can select the music they would like to hear. Providers may also wish to provide other services or access to products other than those that are the main focus of the online provider. In addition to providing a streaming media, such other goods and services, can be offered through the provider's website through an icon or button (e.g., a banner ad).

One way for an online provider to obtain access to such music streaming or other products, goods or services from a third party is for the online provider to contact the marketing or sales department/representative of the third party/company that provides such music streaming, product or the like. Thereafter, the online provider and the company would go through a contractual negotiation process resulting in the signing of a contract with the company so the online provider can thereafter provide the music streaming service or access to the other goods, products or services on its website. Typically, this contract negotiation process can be time consuming, creating a time delay between when the negotiation process is started and the authorization to proceed is obtained. There also can be further delays resulting from the need to incorporate or embed any code or code segments into the website applications programs.

Embodiments of the present disclosure address these and other issues.

### SUMMARY

Embodiments of the present disclosure automatically generate customized media player code segments for integration with the websites of an online provider of goods and services to stream various forms of non-downloadable media (such as audio and video) to visitors of the provider's website. Embodiments of the present disclosure further allow online providers to obtain information relating to usage and performance of the media player.

A computer-implemented method according to one embodiment of the present disclosure includes receiving, by a first computing device and from a second computing device associated with an online provider of one or more of a good and a service, information regarding a web site of the online provider; automatically generating, by the first computing device and based on the information regarding the online provider's web site, a media player code segment configured to integrate with the online provider's web site and play streamed media from the first computing device via the online provider's web site; and providing the code segment to the second computing device.

The present disclosure includes methods and apparatuses which perform these methods, including data processing systems which perform these methods, and computer readable media containing instructions that, when executed by computing systems, cause the computing systems to perform these methods.

Other features will be apparent from the accompanying drawings and from the detailed description which follows.

### BRIEF DESCRIPTION OF THE DRAWINGS

A more complete understanding of certain embodiments may be derived by referring to the detailed description and claims when considered in connection with the following illustrative figures.

FIG. 1 is a flow diagram of a process for an online provider or website owner to register, setup and obtain code segments, instructions and criteria from a third party.

FIG. 2 is an illustrative view of a screenshot of an exemplary homepage of the third party.

FIG. 3 is an illustrative view of a screenshot of an exemplary signup page.

FIG. 4 is an illustrative view of a screenshot of an exemplary account verification page.

FIG. 5 is an illustrative view of a screenshot of an exemplary site settings layer page.

FIG. 6 is an illustrative view of a screenshot of an exemplary statistics page.

FIG. 7 is an illustrative view of a screenshot of an exemplary site setting page.

FIG. 8 is an illustrative view of a screenshot of an exemplary player settings page.

FIG. 9 is an illustrative view of a screenshot of an exemplary code retrieval page.

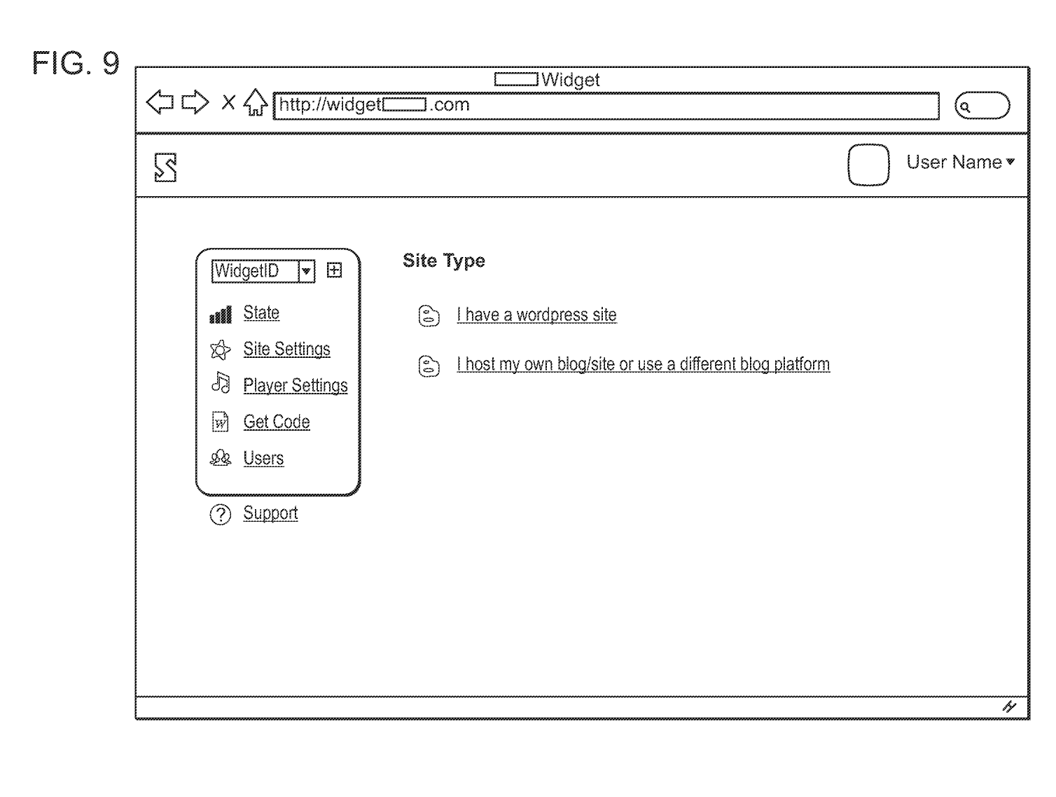

FIG. 10 is an illustrative view of a screenshot of an exemplary code retrieval page with option selected.

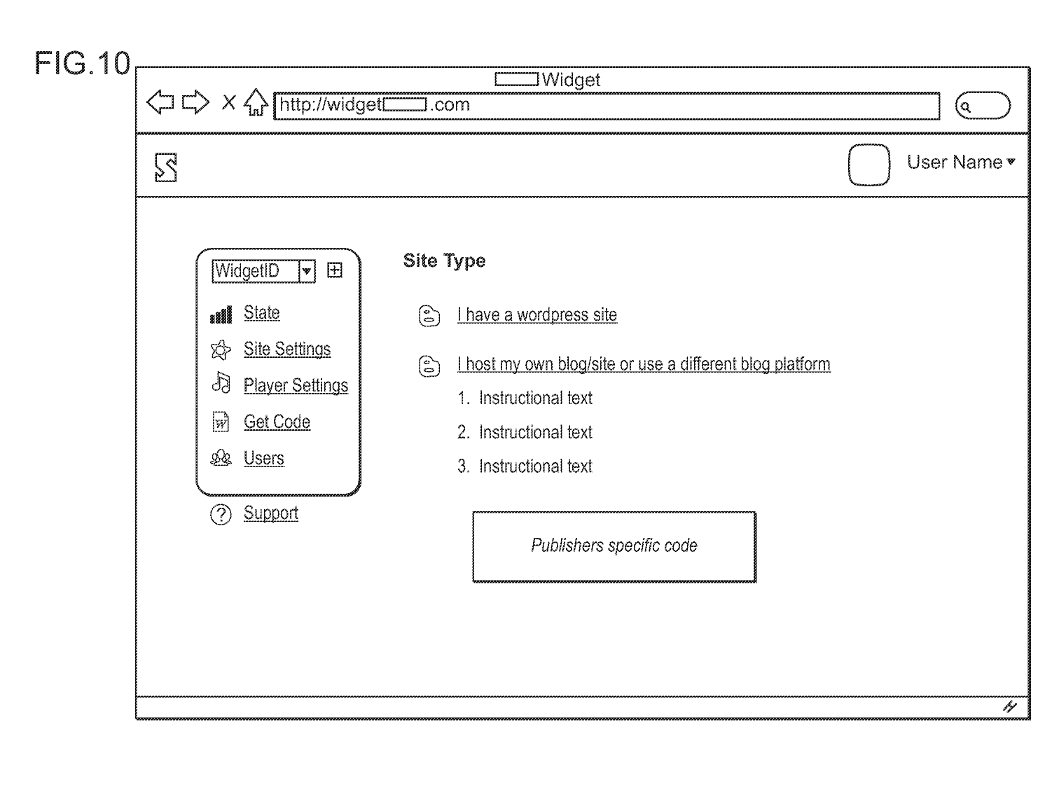

FIG. 11 is an illustrative view of a screenshot of an exemplary user management page.

FIG. 12 is a flow diagram of an exemplary process according to various aspects of the present disclosure.

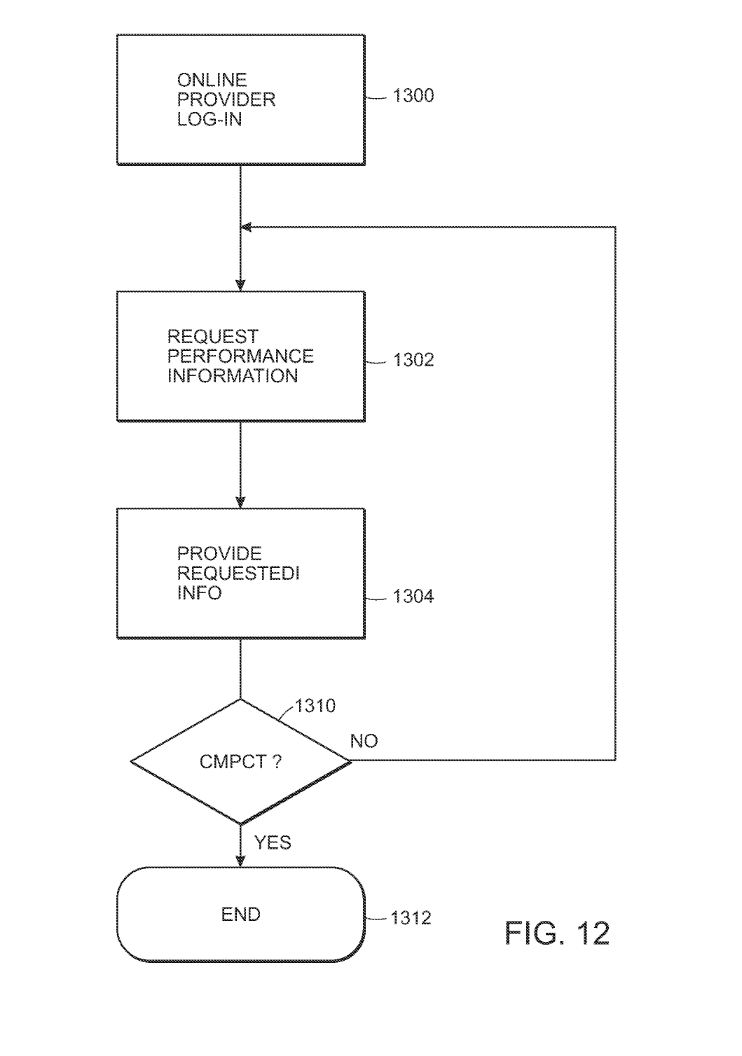

FIG. 13 is an illustrative view of a screenshot of an exemplary stats page after activation and with usage data captured.

FIG. 14 is a block diagram of an exemplary system according to various aspects of the present disclosure.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Any combination and/or subset of the elements of the methods depicted herein may be practiced in any suitable order and in conjunction with any suitable system, device, and/or process. The methods described and depicted herein can be implemented in any suitable manner, such as through software operating on one or more computer systems. The software may comprise computer-readable instructions stored in a tangible computer-readable medium (such as the memory of a computer system) and can be executed by one or more processors to perform the methods of various embodiments.

Among other things, embodiments of the present disclosure can generate code for a customized media player that can be integrated with the website of an online provider of goods and/or services to stream audio and/or video to visitors of the website without allowing the streamed content (such as music files) to be downloaded to the computing device used by the visitor to access the web site. A visitor/end user visiting a website can be provided with a musical experience concurrently with any action the visitor maybe taking with respect to the website (e.g., navigating website to purchase an article, goods or service). In addition, such streaming of the music is seamless with the other website actions so that it appears to the end user that the music is coming from the website, though the music is actually being received from a third party. Embodiments of the present disclosure also allow an online provider to obtain approval from a third party to provide access to products, goods or other services that are supplied by the third party.

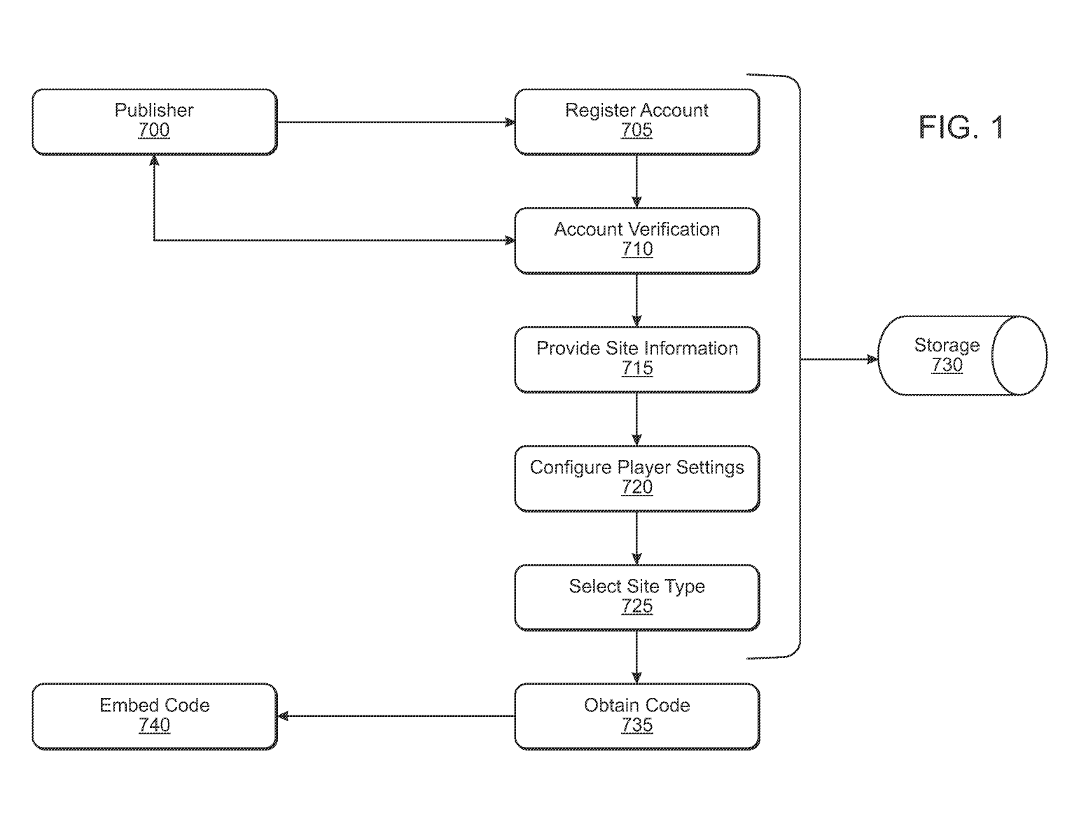

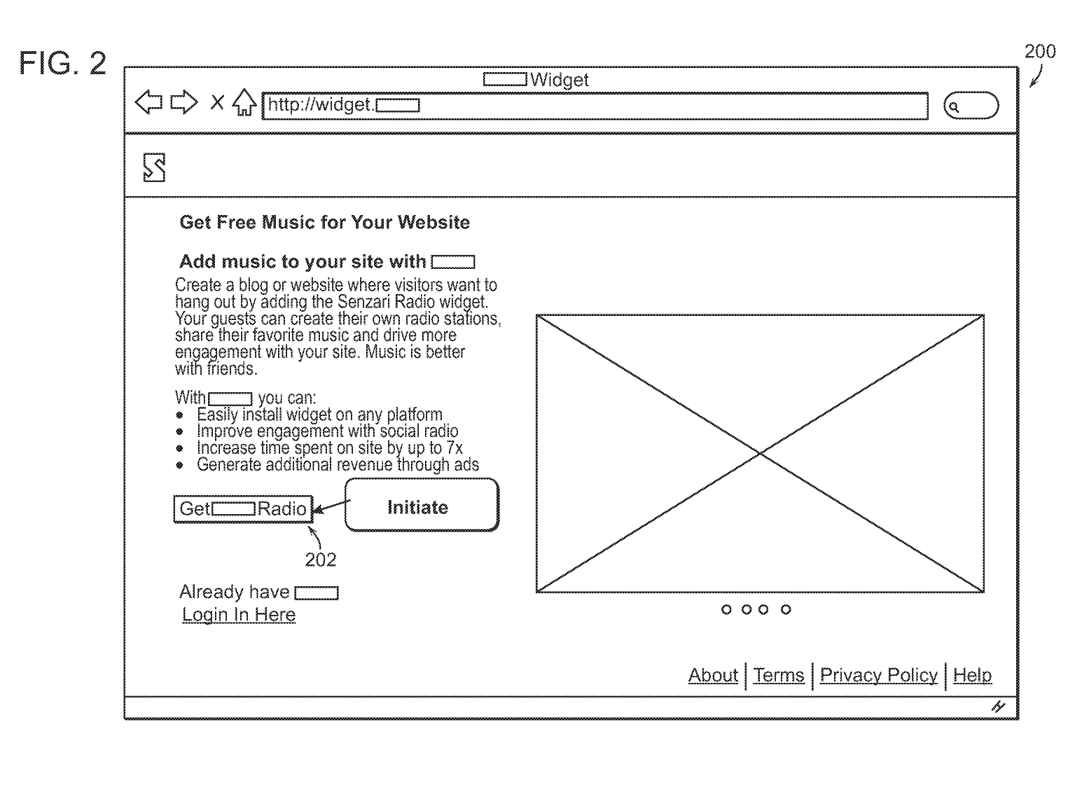

FIG. 1 illustrates an exemplary process according to various aspects of the present disclosure. In this process, an online provider of goods and/or services can take sign up to the music service offered by a third party, configure the settings of the media player, and retrieve the code for a customized media player for integration with the online provider's website as described in more detail herein. In the exemplary process of FIG. 1, the publisher, website owner or online provider (collectively referred to hereinafter as the “online provider”) establishes a communication link (e.g., via, WAN, LAN and/or internet) between the computing device associated with the online provider and to the computing device associated with the third party providing the customized media player code (Step 100). The online provider may connect to the third party's home page 200 (shown in FIG. 2) and actuate a button 202, icon or other feature provided with the home page so as to cause the process to sign up and gain access to the music services provided by the third party to be started.

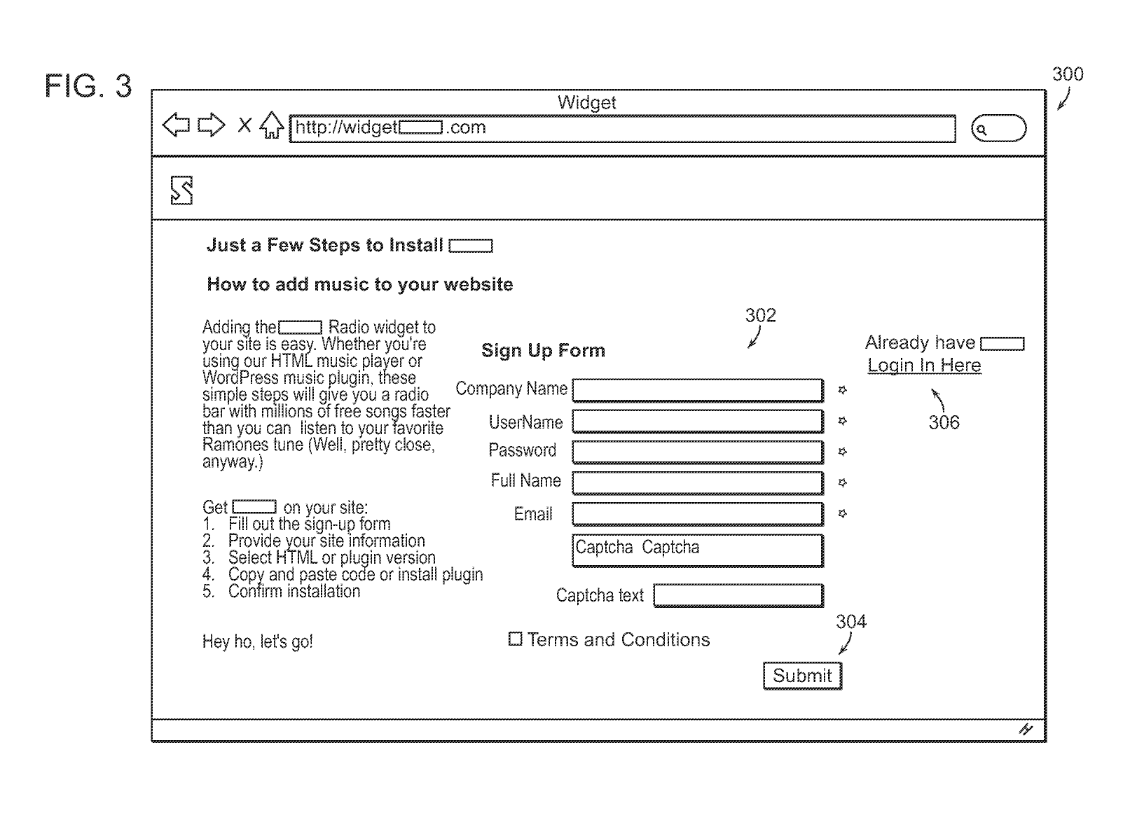

The online provider may register themselves to an account with the third party (Step 105). As illustrated in FIG. 3, the process may cause a sign-up page 300 to pop up so the online provider can sign up for a music service and to generate a customized media player for integration with the online provider's site. More specifically, the online provider may be expected, for example, to fill out the sign-up form, provide their site information, copy and paste the downloaded code segment to its website and provide any confirmation that process is competed. As also shown in FIG. 3, the online provider also may be asked to provide other information 302 such as the company name, a username, a password, the full name and email of the contact person. Upon completion of the form, the online provider would press or activate a button, icon or other feature (e.g., a submit button 304) to cause the sign-up page to be submitted to the third party. In one embodiment, the completed sign-up page is submitted and automatically processed by the third party. In other embodiments, the sign-up page may be submitted and manually processed by the third party.

In the event that the online provider has an account with the third party, then the online provider may be expected to login by actuating the button 306, icon or other feature provided on the sign-up page 300.

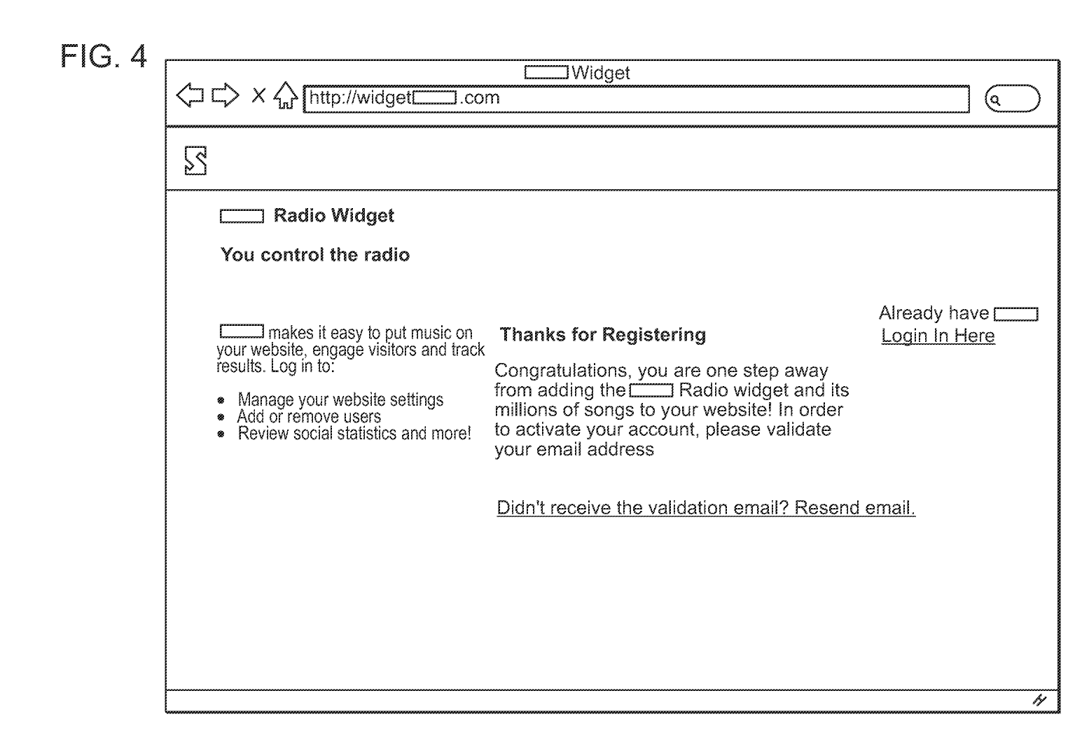

After the online provider has successfully registered, an email is sent to the online provider requesting email confirmation of the account (Step 110). An illustrative view of an exemplary screenshot of an account verification page which includes a sign-up confirmation message is shown in FIG. 4. Preferably, this page also includes further instructions so that the online provider can proceed to the next step in the process.

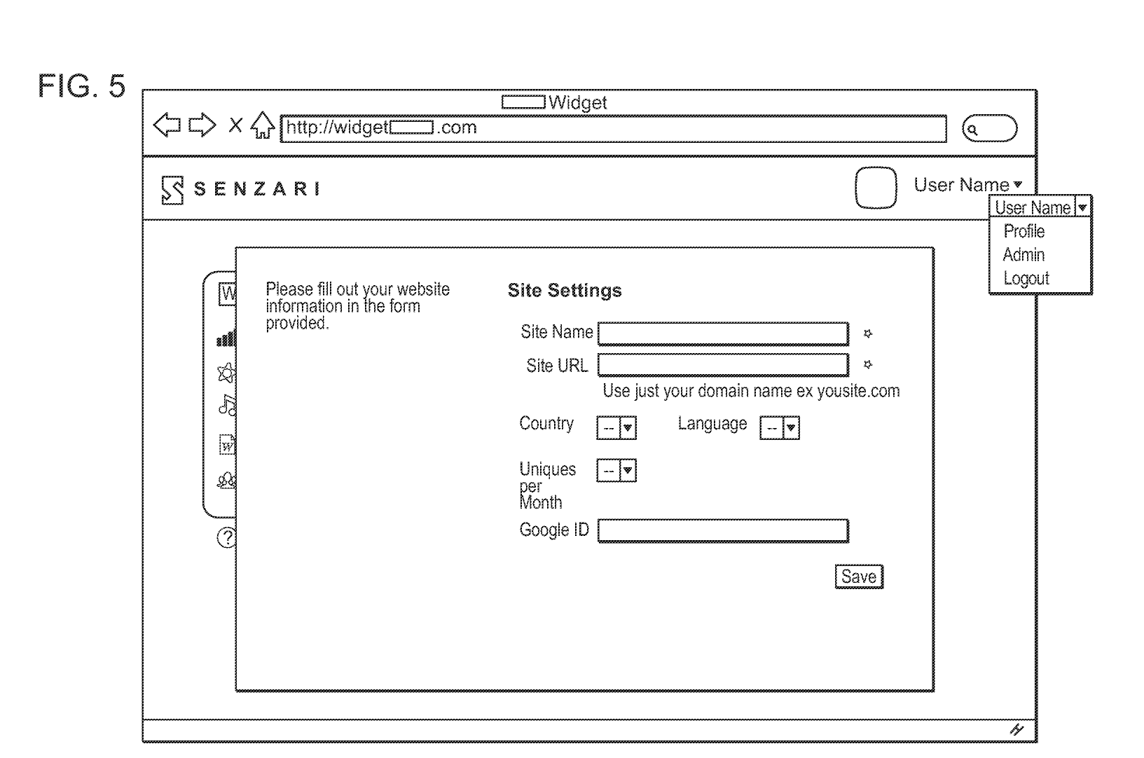

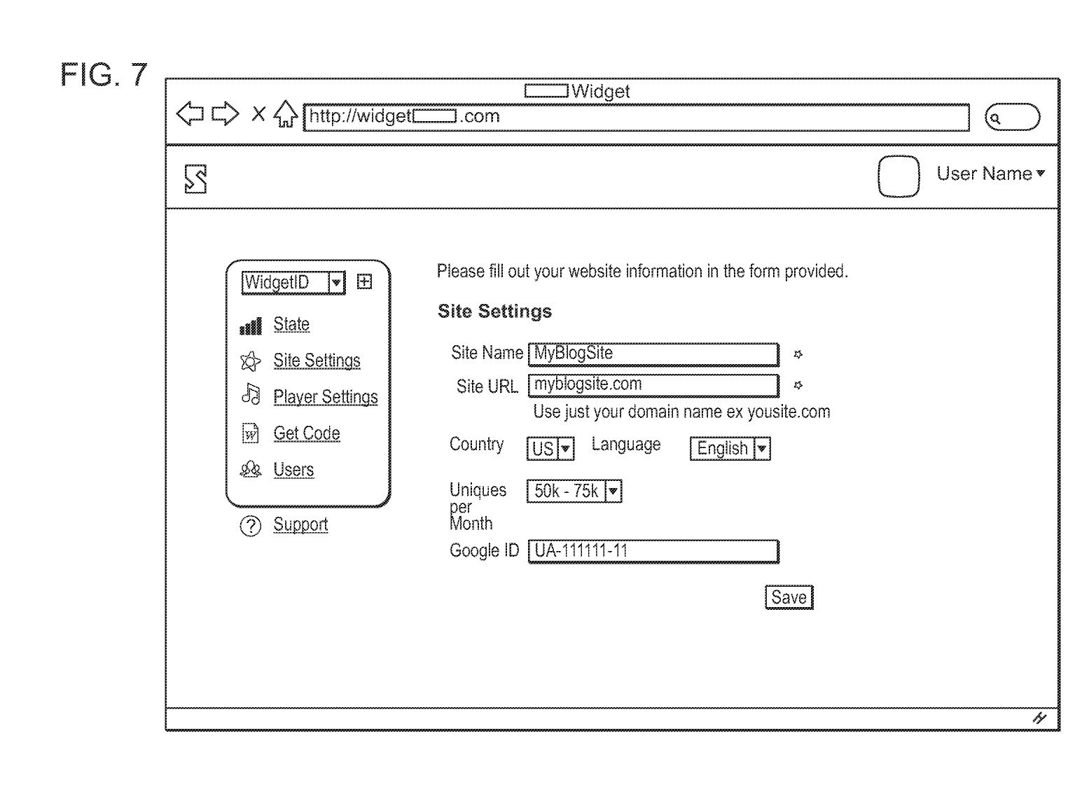

When the online provider clicks on the verification link contained in the confirmation email, they are redirected back to the third party portal in an authenticated state. In particular embodiments, a modal layer with a form is transmitted to the online provider to finish the process. There is shown in FIG. 5 an exemplary screenshot of such a form (e.g., a Site Settings form). There also is shown in FIG. 7 a completed Site Setting form.

As indicated on such a form, the online provider may be requested to provide responses to the informational data fields provided on the form such as site information (i.e., information concerning the online provider's website or site settings) (Step 115).

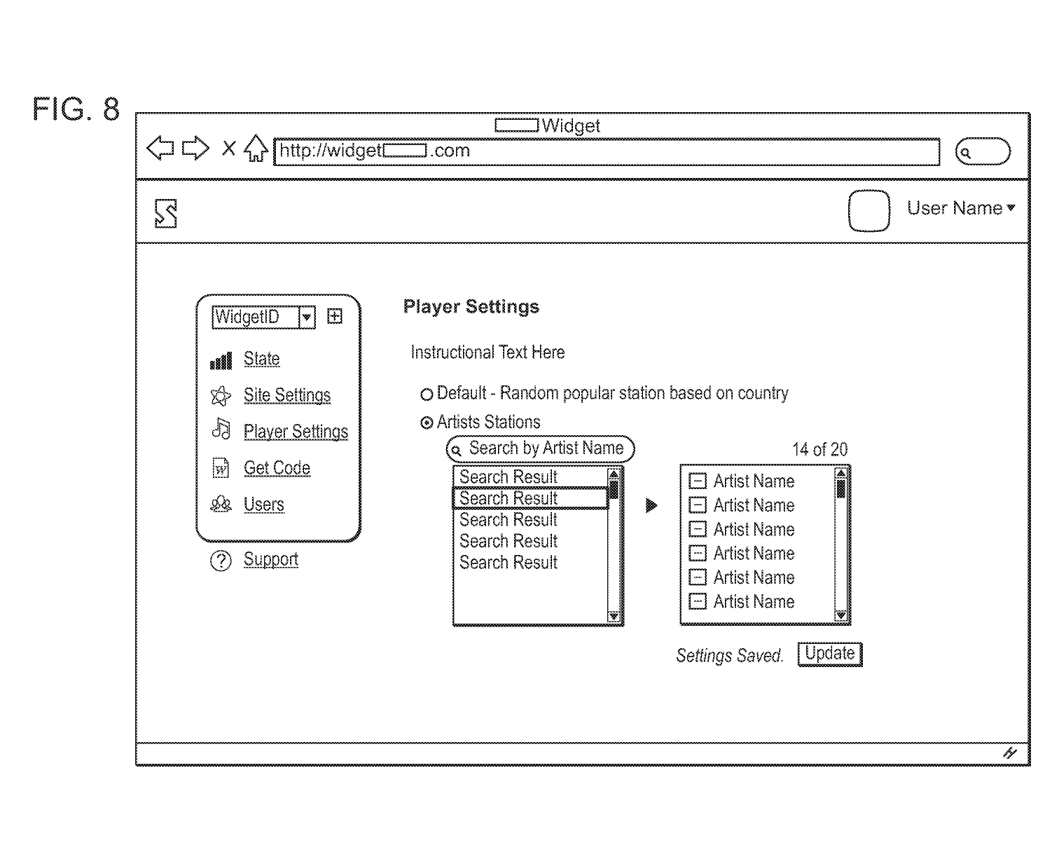

The online provider can configure the player settings (Step 120) to be used for streaming music or other media. In particular, the online provider can select and specify music options that a visitor to the online provider's website can select from. For example, and as shown in FIG. 8, the online provider can select a default setting provided by the third party which can correspond to a random popular station in a given country.

Alternatively, the online provider can override the default setting and specify one or more artists' names such that the visitor to the online provider's website can select an artist from a list. This can allow the online provider to select music and artists that complements its website. For example, if the online provider website is directed to products, goods or services associated with horses (e.g., horse riding clothing and equipment), the online provider could, for example, select and specify country and western artists.

In yet further embodiments, the online provider also can be presented with other options such as different type or genre of music (e.g., pop, heavy metal, classical) and/or artists associated with different types of music from which the visitor could select from. Embodiments of the present disclosure may allow the online provider to configure any other desired parameters, options, or settings associated with the media streaming service.

The online provider also can be offered several integration options, e.g., JS code, word press plugin, etc. that can be appropriate depending upon the type of site. In the exemplary process depicted in FIG. 1, the online provider identifies their site type (Step 125), in response to which the third party computing device auto-generates the scripts, code, and/or files for the media player (Step 135). In various embodiments, the media player scripts, code, and/or files are customized based on the information regarding the online provider's website, and may be further based on configuration settings for the media player provided by the online provider (e.g, via the exemplary page depicted in FIG. 8).

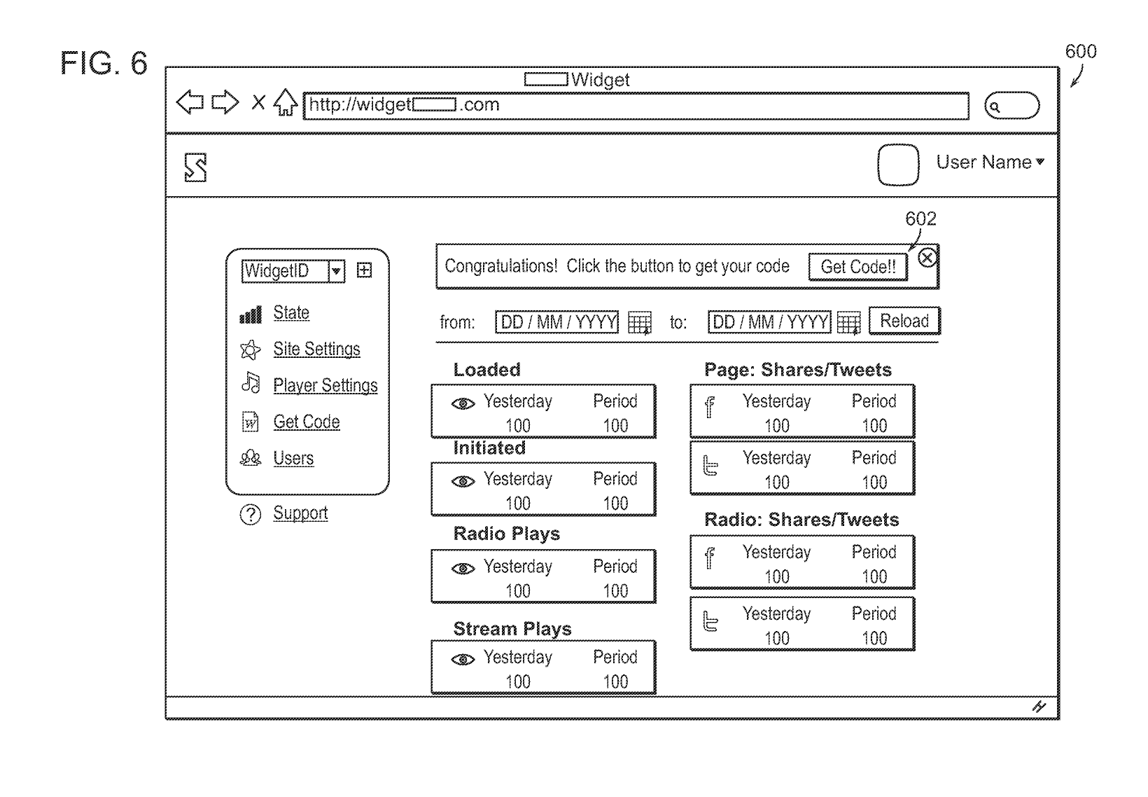

In the process depicted in FIG. 1, the code for the media player is provided to online provider's computing device (Step 140). The media player code may be automatically embedded in the application program(s) associated with the online provider's website. Alternatively, the online provider can be provided with instructions directing the online provider as to how to integrate the music player with their web site. As shown in FIG. 6, the online provider can obtain the code by accessing the stats page 600 and clicking the appropriate button, icon or feature 602 or by utilizing a similar button, icon or feature provided on any other webpage that would allow the online provider to get the code.

The account preference and setting information developed in connection with steps 105, 110, 115, 120, and 125 are preferably stored in a storage device 130 that is associated with and/or connected to the second digital device.

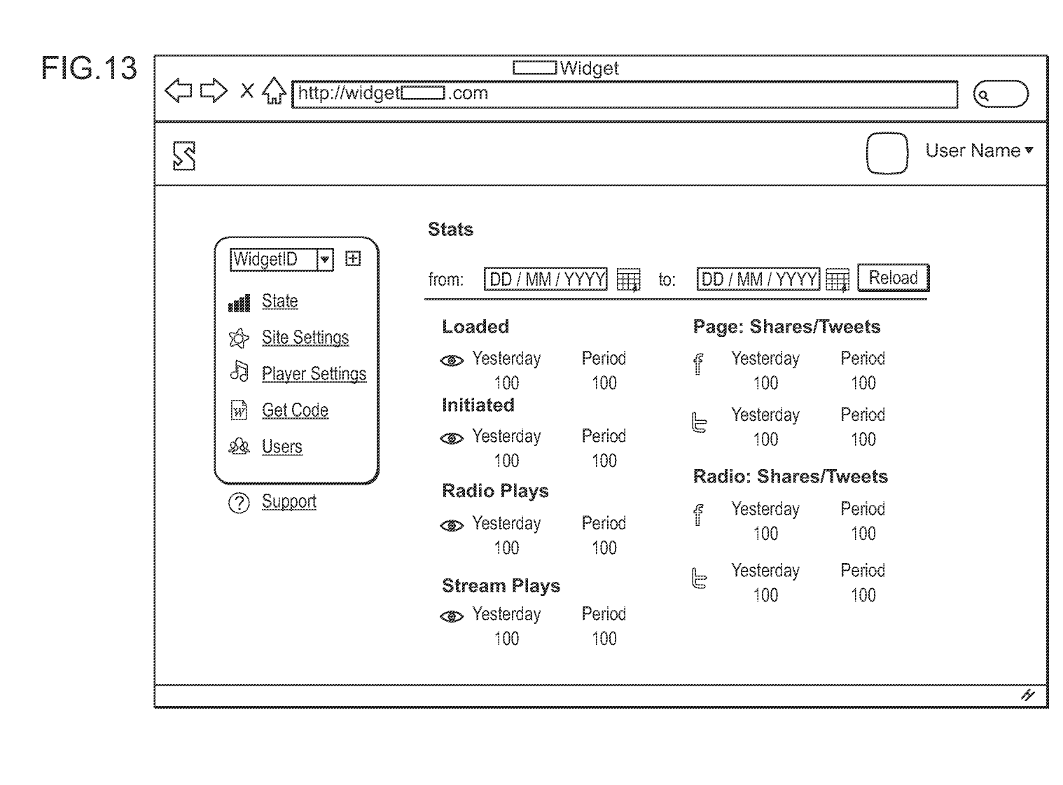

The online provider can obtain information relating to performance and usage of the media player and other services provided by the third party to visitors of the online provider's website. In one exemplary embodiment, referring now to FIG. 13, the online provider can log into the third party's computing device (Step 1300) and request information relating to the performance and/or usage of third party's service by the visitors to the online provider's website (Step 1302).

In response to such a request, the third party's computing device provides the requested information to the online provider (1304). FIG. 13 depicts an exemplary screen shot of statistical information related to the usage and performance of the media player. Thereafter the process can continue with determining if the request for information is complete (Step 1310). If there other performance information to be requested (NO, Step 1310), the process returns to Step 1302 and the online provider again requests that performance related information be provided. If there is no more performance information to be requested (YES, Step 1310), then the process is ended, Step 1312. For example, the process is ended by the online provider logging out or logging off.

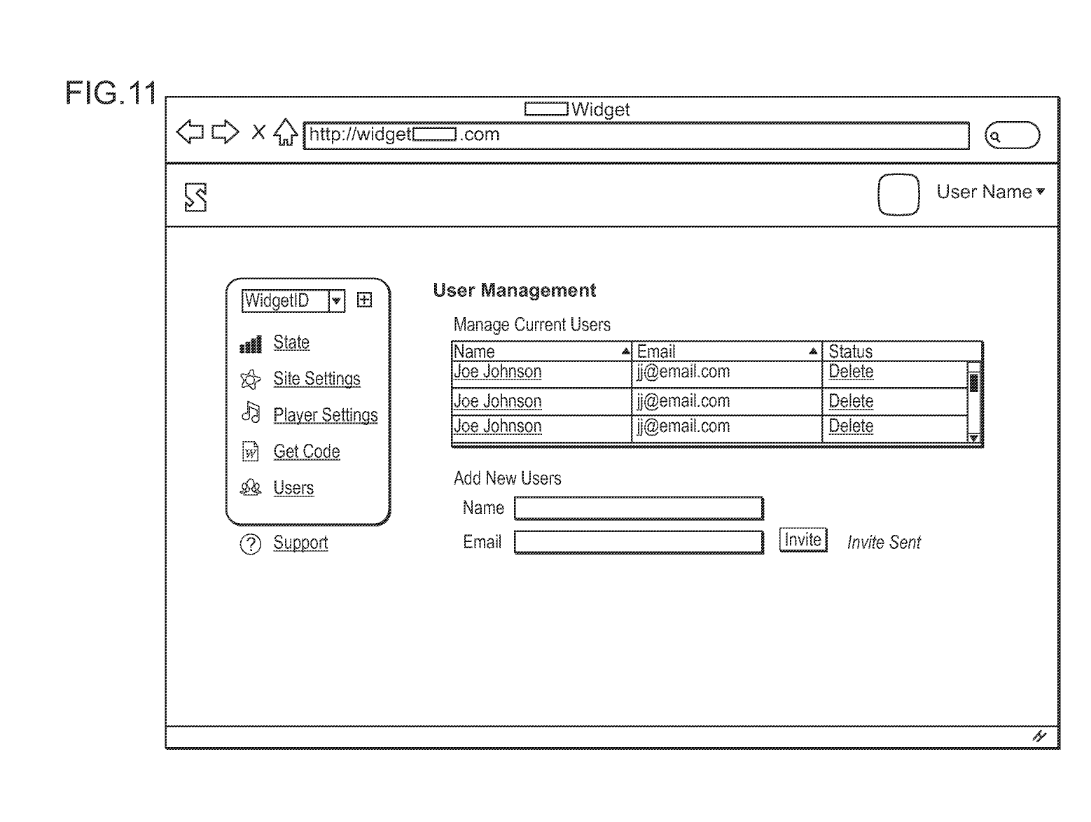

The methods and system of the present disclosure also allow an online provider to manage different aspects of their account. FIG. 11 depicts an exemplary user management page through which the online provider can control who is an authorized user, who is no longer an authorized user and also provide communication related information (e.g., Email address) for the identified users. Such a webpage also can include features allowing the required information to be provided for users being added.

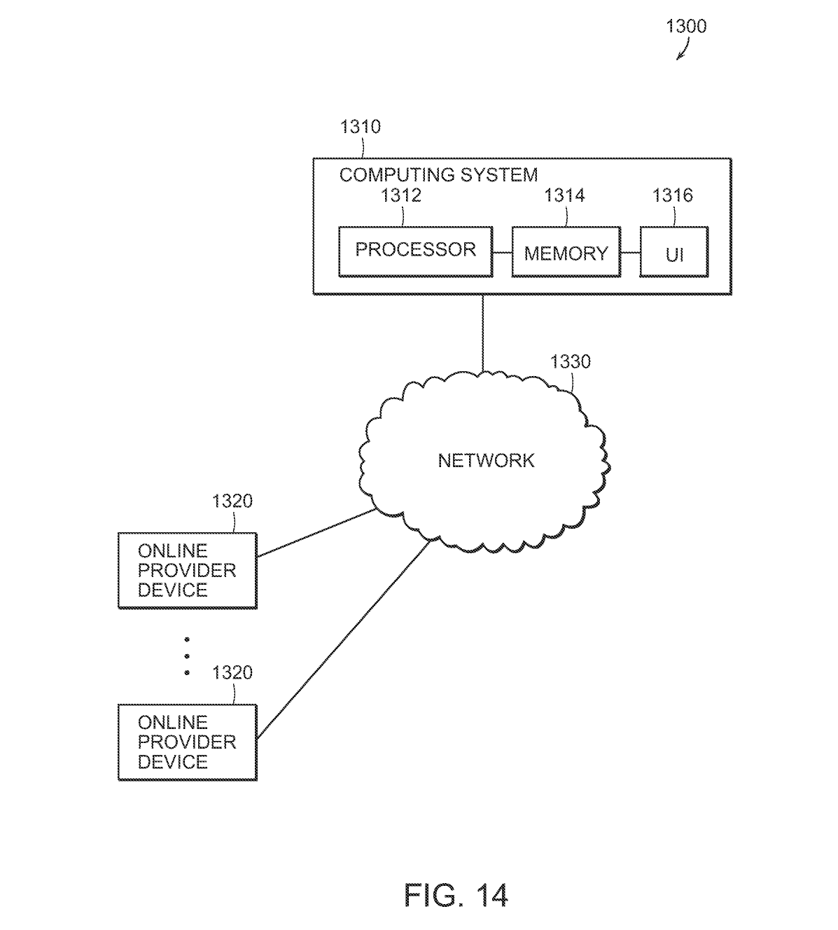

FIG. 14 is a block diagram of system which may be used in conjunction with various embodiments. While FIG. 14 illustrates various components of a computer system, it is not intended to represent any particular architecture or manner of interconnecting the components. Other systems that have fewer or more components may also be used.

In FIG. 14, the system 1400 includes a computer system 1410 comprising a processor 1412, memory 1414, and user interface 1416. Computer system 1410 may include any number of different processors, memory components, and user interface components, and may interact with any other desired systems and devices in conjunction with embodiments of the present disclosure.

The functionality of the computer system 1410, including the steps of the methods described above (in whole or in part), may be implemented through the processor 1412 executing computer-readable instructions stored in the memory 1414 of the system 1410. The memory 1414 may store any computer-readable instructions and data, including software applications, applets, and embedded operating code. Portions of the functionality of the methods described herein may also be performed via software operating on one or more of the online provider devices 1420, such as via integration of the generated media player with a website hosted or otherwise implemented via the online provider devices 1420.

The functionality of the system 1410 or other system and devices operating in conjunction with embodiments of the present disclosure may also be implemented through various hardware components storing machine-readable instructions, such as application-specific integrated circuits (ASICs), field-programmable gate arrays (FPGAs) and/or complex programmable logic devices (CPLDs). Systems according to aspects of certain embodiments may operate in conjunction with any desired combination of software and/or hardware components. The processor 1412 retrieves and executes instructions stored in the memory 1414 to control the operation of the system 1410. Any type of processor, such as an integrated circuit microprocessor, microcontroller, and/or digital signal processor (DSP), can be used in conjunction with embodiments of the present disclosure. A memory 1414 operating in conjunction with embodiments of the disclosure may include any combination of different memory storage devices, such as hard drives, random access memory (RAM), read only memory (ROM), FLASH memory, or any other type of volatile and/or nonvolatile memory. Data can be stored in the memory 1414 in any desired manner, such as in a relational database.

The system 1410 includes a user interface 1416 that may include any number of input devices (not shown) to receive commands, data, and other suitable input. The user interface 1416 may also include any number of output devices (not shown) to provides the user with data, notifications, and other information. Typical I/O devices may include mice, keyboards, modems, network interfaces, printers, scanners, video cameras and other devices.

The system 1410 may communicate with one or more online provider devices 1420, as well as other systems and devices in any desired manner, including via network 1430. The online provider devices 1420 may include, or be coupled to, one or more control systems (not shown) through which the system 1410 communicates with, or the system 1410 may communicate directly with the online provider devices 1420.

The system 1410 and/or online provider devices 1420 may be, include, or operate in conjunction with, a laptop computer, a desktop computer, a mobile subscriber communication device, a mobile phone, a personal digital assistant (PDA), a tablet computer, an electronic book or book reader, a digital camera, a video camera, a video game console, and/or any other suitable computing device.

The network 1430 may include any electronic communications system or method. Communication among components operating in conjunction with embodiments of the present disclosure may be performed using any suitable communication method, such as, for example, a telephone network, an extranet, an intranet, the Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Systems and devices of the present disclosure may utilize TCP/IP communications protocols as well as IPX, Appletalk, IP-6, NetBIOS, OSI, any tunneling protocol (e.g. IPsec, SSH), or any number of existing or future protocols.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

A machine readable medium can be used to store software and data that, when executed by a computer system, causes the computer system to perform various methods. The executable software and data may be stored in various types of memory, including ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

In various embodiments, hardwired circuitry may be used in combination with software instructions to implement the methods described herein. Thus, such methods are neither limited to any specific combination of hardware circuitry and software, nor to any particular source for the instructions executed by the data processing system.

Although some of the drawings illustrate a number of operations in a particular order, operations which are not order dependent may be reordered and other operations may be combined or broken out. While some reordering or other groupings may be specifically mentioned, others will be apparent to those of ordinary skill in the art and so do not present an exhaustive list of alternatives. Moreover, it should be recognized that the stages could be implemented in hardware, firmware, software or any combination thereof.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

Various functionality may be performed via a web browser and/or application interfacing utilizing a web browser. Such browser applications may comprise Internet browsing software installed within a computing unit or a system to perform various functions. These computing units or systems may take the form of a computer or set of computers, and any type of computing device or systems may be used, including laptops, notebooks, tablets, hand held computers, personal digital assistants, set-top boxes, workstations, computer-servers, main frame computers, mini-computers, PC servers, network sets of computers, personal computers and tablet computers, such as iPads, iMACs, and MacBooks, kiosks, terminals, point of sale (POS) devices and/or terminals, televisions, or any other device capable of receiving data over a network. Various embodiments may utilize Microsoft Internet Explorer, Mozilla Firefox, Google Chrome, Apple Safari, Opera, or any other of the myriad software packages available for browsing the Internet.

Various embodiments may operate in conjunction with any suitable operating system (e.g., Windows NT, 95/98/2000/CE/Mobile/, Windows 7/8, OS2, UNIX, Linux, Solaris, MacOS, PalmOS, etc.) as well as various conventional support software and drivers typically associated with computers. Various embodiments may include any suitable personal computer, network computer, workstation, personal digital assistant, cellular phone, smart phone, minicomputer, mainframe or the like. Embodiments may implement security protocols, such as Secure Sockets Layer (SSL), Transport Layer Security (TLS), and Secure Shell (SSH). Embodiments may implement any desired application layer protocol, including http, https, ftp, and sftp.

The various system components may be independently, separately or collectively suitably coupled to a network via data links which includes, for example, a connection to an Internet Service Provider (ISP) over the local loop as is typically used in connection with standard modem communication, cable modem, satellite networks, ISDN, Digital Subscriber Line (DSL), or various wireless communication methods. It is noted that embodiments of the present disclosure may operate in conjunction with any suitable type of network, such as an interactive television (ITV) network.

Embodiments of the present disclosure may be partially or fully implemented using cloud computing. “Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand.

Various embodiments may be used in conjunction with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically.

Any databases, systems, devices, servers or other components of the system may be located at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, and symmetric and asymmetric cryptosystems.

Embodiments may connect to the Internet or an intranet using standard dial-up, cable, DSL or any other Internet protocol known in the art. Transactions may pass through a firewall in order to prevent unauthorized access from users of other networks.

The computers discussed herein may provide a suitable website or other Internet-based graphical user interface which is accessible by users. For example, the Microsoft Internet Information Server (IIS), Microsoft Transaction Server (MTS), and Microsoft SQL Server, may be used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In another example, an Apache web server can be used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL and an IP address. The web server retrieves the appropriate web pages and sends the data or applications for the web pages to the IP address. Web services are applications that are capable of interacting with other applications over a communications means, such as the Internet.

Various embodiments may employ any desired number of methods for displaying data within a browser-based document. For example, data may be represented as standard text or within a fixed list, scrollable list, drop-down list, editable text field, fixed text field, pop-up window, and the like. Likewise, embodiments may utilize any desired number of methods for modifying data in a web page such as, for example, free text entry using a keyboard, selection of menu items, check boxes, option boxes, and the like.

The exemplary systems and methods illustrated herein may be described in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, AWK, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like.

The systems and methods of the present disclosure may be embodied as a customization of an existing system, an add-on product, a processing apparatus executing upgraded software, a stand alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” should be construed to exclude only those types of transitory computer-readable media which were found in In Re Nuijten to fall outside the scope of patentable subject matter under 35 U.S.C. §101.

Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

Changes and modifications may be made to the disclosed embodiments without departing from the scope of the present disclosure. These and other changes or modifications are intended to be included within the scope of the present disclosure, as expressed in the following claims.

What is claimed is:

1. A computer-implemented method comprising:
receiving, by a first computing device and from a second computing device associated with an online provider of one or more of a good and a service, information regarding a web site of the online provider;
automatically generating, by the first computing device and based on the information regarding the online provider's web site, a media player code segment configured to integrate with the online provider's web site and play streamed media from the first computing device via the online provider's web site; and
providing the code segment to the second computing device.

2. The method of claim 1, further comprising:
receiving account registration information from the online provider; and
creating an account for the online provider based on the account registration information.

3. The method of claim 2, further comprising verifying the online provider's account, wherein providing the code segment to the second device is predicated on a successful verification of the online provider's account.

4. The method of claim 1, wherein the information regarding the online provider's web site includes one or more of: a name of the online provider's web site, a uniform resource locator for the online provider's web site, a number of unique visitors to the online provider's web site over a predetermined period of time, and a tracking code associated with the online provider's web site.

5. The method of claim 4, wherein the information regarding the online provider's web site includes a range of unique visitors to the online provider's web site over the predetermined period of time.

6. The method of claim 1, further comprising receiving, from the online provider, configuration information for the media player, wherein generation of the media player code segment is further based on the configuration information.

7. The method of claim 6, wherein the configuration information from the online provider includes an identification of one or more of: an artist associated with the streamed media to be played via the online provider's website, and a genre associated with the streamed media to be played via the online provider's website.

8. The method of claim 1, wherein the media player is configured to play streamed media comprising one or more of audio and video.

9. The method of claim 1, wherein providing the code segment includes automatically embedding the code segment into a software application associated with the online provider's website.

10. The method of claim 1, wherein providing the code segment includes providing instructions for integrating the media player with the online provider's website.

11. The method of claim 1, further comprising providing the online provider with information related to the media player that includes one or more of: information regarding performance of the media player, and information regarding usage of the media player by visitors to the online provider's website.

12. A tangible, non-transitory computer-readable medium storing instructions that, when executed, cause a first computing device to:
receive, from a second computing device associated with an online provider of one or more of a good and a service, information regarding a web site of the online provider;
automatically generate, based on the information regarding the online provider's web site, a media player code segment configured to integrate with the online provider's web site and play streamed media from the first computing device via the online provider's web site; and
provide the code segment to the second computing device.

13. The computer-readable medium of claim 12, wherein the medium further stores instructions to cause the first computing device to:
receive account registration information from the online provider; and
create an account for the online provider based on the account registration information.

14. The computer-readable medium of claim 13, wherein the medium further stores instructions to cause the first computing device to verify the online provider's account, wherein providing the code segment to the second device is predicated on a successful verification of the online provider's account.

15. The computer-readable medium of claim 12, wherein the information regarding the online provider's web site includes one or more of: a name of the online provider's web site, a uniform resource locator for the online provider's web site, a number of unique visitors to the online provider's web site over a predetermined period of time, and a tracking code associated with the online provider's web site.

16. The computer-readable medium of claim 15, wherein the information regarding the online provider's web site includes a range of unique visitors to the online provider's web site over the predetermined period of time.

17. The computer-readable medium of claim 12, wherein the medium further stores instructions to cause the first computing device to receive, from the online provider, configuration information for the media player, wherein generation of the media player code segment is further based on the configuration information.

18. The computer-readable medium of claim 17, wherein the configuration information from the online provider includes an identification of one or more of: an artist associated with the streamed media to be played via the online provider's website, and a genre associated with the streamed media to be played via the online provider's website.

19. The computer-readable medium of claim 12, wherein the media player is configured to play streamed media comprising one or more of audio and video.

20. A system comprising:
at least one processor; and
memory in communication with the at least one processor and storing instructions that, when executed by the processor, cause the system to:
receive, from a computing device associated with an online provider of one or more of a good and a service, information regarding a web site of the online provider;
automatically generate, based on the information regarding the online provider's web site, a media player code segment configured to integrate with the online provider's web site and play streamed media from the system via the online provider's web site; and
provide the code segment to the online provider's computing device.
